(19) United States
(12) Patent Application Publication
(10) Pub. No.: US 2026/0291068 A1
(43) Pub. Date: Sep. 24, 2026

(54) LOW-COST DUAL-POLARIZED RADIATING ELEMENTS HAVING CLOAKING STRUCTURES

(71) Applicant: Outdoor Wireless Networks LLC, Richardson, TX (US)

(72) Inventors: Bin Sun, Suzhou (CN); Changfu Chen, Suzhou (CN); Cheng Xue, Suzhou (CN); Jian Zhang, Suzhou (CN); Pengfei Guo, Suzhou (CN)

(21) Appl. No.: 19/573,114

(22) Filed: Mar. 20, 2026

(30) Foreign Application Priority Data
Mar. 24, 2025 (CN) 202510353618.4

(51) Int. Cl. H01Q 5/48; H01Q 1/24

(52) U.S. Cl. CPC H01Q 5/48; H01Q 1/246

(57) ABSTRACT

Radiating elements are provided that comprise a feed stalk, a first dipole radiator that comprises a first dipole arm and a second dipole arm, and a second dipole radiator that comprises a third dipole arm and a fourth dipole arm. The first dipole arm comprises a conductive loop and a conductive pad that is at least partially surrounded by the conductive loop and is only capacitively coupled to the conductive loop.

### CROSS-REFERENCE TO RELATED APPLICATION

The present application claims priority to Chinese Patent Application No. 202510353618.4, filed on Mar. 24, 2025, the entire contents of which are incorporated herein by reference.

### TECHNICAL FIELD

The present invention generally relates to radio communications and, more particularly, to base station antennas for cellular communications systems and to radiating elements for such base station antennas.

### BACKGROUND OF THE INVENTION

Cellular communications systems are well known in the art. In a cellular communications system, a geographic area is divided into a series of regions that are referred to as “cells” which are served by respective base stations. Each base station includes baseband equipment, radios and base station antennas that are configured to provide two-way radio frequency (“RF”) communications with subscribers that are positioned throughout the cell served by the base station. The base station antennas are often mounted on a tower or other raised structure, with the radiation pattern (“antenna beam”) that is generated by each antenna directed outwardly to serve a respective sector. Typically, a base station antenna includes multiple phase-controlled arrays of radiating elements, with the radiating elements arranged in vertically-extending columns that are referred to as “linear arrays”. Herein, “vertical” refers to a direction that is generally perpendicular relative to the plane defined by the horizon. References will also be made herein to the “azimuth” plane, which refers to a horizontal plane that bisects the base station antenna that is parallel to the plane defined by the horizon.

Most cells are divided into a plurality of “sectors”, and separate base station antennas provide coverage (service) to each of the sectors. The most common base station configuration is the so-called “three sector configuration” in which a cell is divided into three 120° “sectors” in the azimuth plane. In a three sector configuration, the antenna beams generated by the linear arrays typically have half power beamwidths in the azimuth plane (“azimuth HPBW”) of about 65° (i.e., the angle subtended in the azimuth plane by the portion of the antenna beam that has a gain that is within 3 dB of the peak gain is about 65°) . Generally speaking, an antenna beam having an azimuth HPBW of about 65° will provide reasonably good coverage throughout a 120° sector without having excessive spillover of RF energy into adjacent sectors. Such spillover of RF energy into adjacent cells is undesirable both because it reduces the gain of the antenna beam within the sector and because the spillover appears as interference to the antenna beams in the adjacent sectors.

Typically, each base station antenna will include multiple linear arrays of radiating elements that operate, for example, using second generation (“2G”), third generation (“3G”) or fourth generation (“4G”) cellular network protocols. The linear arrays may be “perfect” columns of radiating elements where all of the radiating elements are aligned along a vertically-extending axis, or may be “staggered” columns in which some of the radiating elements are staggered horizontally (and may even be aligned with an adjacent column of radiating elements) in order to reduce (narrow) the azimuth HPBW of the antenna beams generated by the linear arrays. Most modern base station antennas include both “low-band” linear arrays of radiating elements that support service in some or all of the 617-960 megahertz (MHz) frequency band and “mid-band” linear arrays of radiating elements that support service in some or all of the 1427-2690 MHz frequency band. These linear arrays are typically formed using dual-polarized radiating elements, which allows each linear array to transmit and receive RF signals at two orthogonal polarizations.

The radiating elements of each of the above-described linear arrays are coupled to two ports of a radio (one port for each polarization). An RF signal that is to be transmitted by a linear array is passed from the radio port to the antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a sector of a cell. Since the antenna beams generated by the above-described 2G/3G/4G linear arrays generate fixed (static) antenna beams, they are often referred to as “passive” linear arrays.

Most cellular operators are currently upgrading their networks to support fifth generation (“5G”) cellular service. One important component of 5G cellular service is the use of so-called “active” beamforming arrays that operate in conjunction with “active” beamforming radios to dynamically adjust the size, shape and pointing direction of the antenna beams that are generated by the active beamforming array. Active beamforming arrays are typically formed using “high-band” radiating elements that operate in higher frequency bands, such as some or all of the 3.1-4.2 gigahertz (GHz) and/or the 5.1-5.8 GHz frequency bands, although active beamforming arrays may also be provided that operate in the upper portion of the mid-band frequency range (e.g., 2300-2690 MHz). Many modern base station antennas include both passive low-band and mid-band linear arrays plus one or more 5G beamforming arrays. Moreover, in order to support higher order multi-input-multi-output (“MIMO”) communication techniques (e.g., 4xMIMO or 8xMIMO) and/or to provide service in multiple sub-bands of the mid-band frequency range, many base station antennas include multiple (e.g., two or four) low-band and/or mid-band linear arrays.

While there is commercial interest in base station antennas that have many different arrays of radiating elements, cost is a major concern for cellular network operators and hence cellular network operators may not always deploy base station antennas that maximize performance in order to reduce cost. In addition, cellular network operators also often have strict limits on the widths of various types of base station antennas. Base station antennas are often mounted on antenna towers hundreds of feet above the ground and can be subject to very high wind levels. As a base station antenna is made wider, the wind loading increases, requiring that the base station antenna, its mounting hardware, and the antenna tower itself have increased structural durability. Thus, as the number of arrays included in a base station antenna is increased, the spacing between the arrays typically must be decreased to keep the width of the antenna within cellular network operator specified limits. Unfortunately, as the spacing between arrays is decreased, the adjacent arrays tend to interact with each other in undesirable ways, which can degrade the performance of the base station antenna. Thus, there is a need for low-cost base station antennas that support a wide variety of services while also fitting within cellular network operator expectations for the width of the base station antenna.

### SUMMARY OF THE INVENTION

Pursuant to some embodiments of the present invention, radiating elements are provided that comprise a feed stalk, a first dipole radiator that comprises a first dipole arm and a second dipole arm, and a second dipole radiator that comprises a third dipole arm and a fourth dipole arm, wherein the first dipole arm comprises a conductive loop and a conductive pad that is at least partially surrounded by the conductive loop and is only capacitively coupled to the conductive loop.

In some embodiments, the conductive pad is spaced apart from the conductive loop.

In some embodiments, the conductive loop encloses all but one side of the conductive pad in a front view.

In some embodiments, the conductive pad has a rectangular shape.

In some embodiments, a length of the conductive pad in a first direction parallel to a major surface of the conductive pad is greater than a width of the conductive pad in a second direction parallel to the major surface of the conductive pad and perpendicular to the first direction.

In some embodiments, the conductive loop comprises a first meandered segment.

In some embodiments, the first meandered segment is adjacent a distal end of the first dipole arm.

In some embodiments, the first meandered segment extends outward from the conductive loop and terminates in a free end.

In some embodiments, the first meandered segment has a wave structure that includes at least one outer bend and at least one inner bend.

In some embodiments, the conductive loop further comprises a second meandered segment adjacent the first meandered segment.

In some embodiments, the first meandered segment and the second meandered segment extend outward from the conductive loop in a symmetrical manner.

In some embodiments, the first and second dipole radiators are formed in a dipole radiator printed circuit board that comprises a dielectric substrate and a metallization pattern on a major surface of the dielectric substrate, and the conductive loop and the conductive pad are part of the metallization pattern.

In some embodiments, the conductive pad is not galvanically coupled to any conductive elements of the dipole radiator printed circuit board.

In some embodiments, a portion of the conductive loop extends inward in a direction away from a perimeter of the first dipole arm and at least partially surrounds the conductive pad.

In some embodiments, the first through fourth dipole arms are configured to be substantially transparent to RF radiation in a 1.4-2.7 GHz frequency band.

In some embodiments, the feed stalk comprises a feed stalk printed circuit board that includes a first feed line for the first dipole radiator.

Pursuant to additional embodiments of the present invention, radiating elements are provided that comprise a feed stalk, a first dipole radiator that comprises a first dipole arm and a second dipole arm, and a second dipole radiator that comprises a third dipole arm and a fourth dipole arm, wherein the first dipole arm comprises a conductive loop, the conductive loop comprising a first embedded loop, a first conductive pad located in an interior of the first embedded loop, and a first arm segment that extends between the first embedded loop and the first conductive pad.

In some embodiments, the first conductive pad has a rectangular shape.

In some embodiments, the interior of the first embedded loop has an L shape.

In some embodiments, the first conductive pad is galvanically coupled to the first embedded loop through the first arm segment.

In some embodiments, the conductive loop further comprises a meandered segment that extends from the first embedded loop.

In some embodiments, the meandered segment extends outward from the first embedded loop and terminates in a free end.

In some embodiments, the meandered segment is adjacent a distal end of the first dipole arm.

In some embodiments, the conductive loop further comprises a second embedded loop adjacent the first embedded loop, a second conductive pad located in an interior of the second embedded loop, and a second arm segment that extends between the second embedded loop and the second conductive pad.

In some embodiments, the first conductive pad and the second conductive pad have a same shape.

In some embodiments, a portion of the conductive loop extends inward in a first direction away from a perimeter of the first dipole arm, and the first conductive pad is spaced apart from the second conductive pad in a second direction perpendicular to the first direction.

In some embodiments, the first dipole arm further comprises a third conductive pad that is at least partially surrounded by the conductive loop and is adjacent the first conductive pad and the second conductive pad.

In some embodiments, the third conductive pad is only capacitively coupled to the conductive loop.

In some embodiments, the third conductive pad is spaced apart from the first conductive pad and the second conductive pad in a first direction, and the first conductive pad is spaced apart from the second conductive pad in a second direction perpendicular to the first direction.

In some embodiments, an area of the third conductive pad is greater than an area of at least one of the first conductive pad or the second conductive pad.

Pursuant to further embodiments of the present invention, radiating elements are provided that comprise a feed stalk, a first dipole radiator that comprises a first dipole arm and a second dipole arm, and a second dipole radiator that comprises a third dipole arm and a fourth dipole arm, wherein the first dipole arm comprises a conductive pad and a conductive loop that at least partially surrounds the conductive pad and extends adjacent the conductive pad on all sides thereof in a front view.

In some embodiments, the conductive pad is only capacitively coupled to the conductive loop.

In some embodiments, the conductive pad is spaced apart from the conductive loop.

In some embodiments, the conductive loop encloses all but one of the sides of the conductive pad in a front view.

In some embodiments, a first portion of the conductive loop extends adjacent a perimeter of the first dipole arm, and a second portion of the conductive loop protrudes from the first portion of the conductive loop in a direction away from the perimeter of the first dipole arm.

In some embodiments, the second portion of the conductive loop at least partially surrounds the conductive pad.

In some embodiments, the first portion of the conductive loop is closer to the perimeter of the first dipole arm than the conductive pad is.

Pursuant to still further embodiments of the present invention, radiating elements are provided that comprise a feed stalk, a first dipole radiator that comprises a first dipole arm and a second dipole arm, and a second dipole radiator that comprises a third dipole arm and a fourth dipole arm, wherein the first dipole arm comprises one or more conductive elements that are configured to provide an equivalent circuit comprising a first LC circuit that comprises a first inductive element and a first capacitive element connected in electrical parallel, a second LC circuit that comprises a second inductive element and a second capacitive element connected in electrical parallel, and a third inductive element connected in electrical series between the first LC circuit and the second LC circuit.

In some embodiments, an inductance value of the first inductive element is substantially equal to an inductance value of the second inductive element.

In some embodiments, an inductance value of the third inductive element is greater than an inductance value of at least one of the first inductive element or the second inductive element.

In some embodiments, the inductance value of the third inductive element is at least five times greater than the inductance value of the at least one of the first inductive element or the second inductive element.

In some embodiments, a capacitance value of the first capacitive element is substantially equal to a capacitance value of the second capacitive element.

In some embodiments, the first LC circuit, the second LC circuit, and the third inductive element connected in electrical series provide a third LC circuit of the equivalent circuit, and the equivalent circuit further comprises a third capacitive element connected in electrical parallel with the third LC circuit.

In some embodiments, a capacitance value of the third capacitive element is greater than a capacitance value of at least one of the first capacitive element or the second capacitive element.

In some embodiments, the capacitance value of the third capacitive element is at least 1.5 times greater than the capacitance value of the at least one of the first capacitive element or the second capacitive element.

In some embodiments, the one or more conductive elements comprise a conductive loop and a conductive pad that is at least partially surrounded by a portion of the conductive loop, and the conductive pad is only capacitively coupled to the portion of the conductive loop to provide the third capacitive element.

In some embodiments, the one or more conductive elements are configured such that the first dipole arm is substantially transparent to RF radiation in a 1.4-2.7 GHz frequency band.

### BRIEF DESCRIPTION OF THE DRAWINGS

FIG. 1A is a perspective view of a conventional multiband base station antenna.

FIG. 1B is a schematic front view of the conventional base station antenna of FIG. 1A with the radome removed that illustrates an antenna assembly of the antenna.

FIG. 2A is a front perspective view of a low-band radiating element according to embodiments of the present invention.

FIG. 2B is a front view of four dipole arms included in the radiating element of FIG. 2A.

FIG. 2C is an enlarged view of a region ‘A’of FIG. 2B.

FIG. 2D is a side view illustrating a first major surface of a feed stalk printed circuit board included in the radiating element of FIG. 2A.

FIG. 2E is a side view illustrating a second major surface of the feed stalk printed circuit board included in the radiating element of FIG. 2A.

FIG. 3 is a circuit diagram illustrating an equivalent circuit of a conductive segment of FIG. 2C according to embodiments of the present invention.

FIG. 4 is an enlarged view of the region ‘A’ of FIG. 2B according to further embodiments of the present invention.

### DETAILED DESCRIPTION

The size of a radiating element is generally inversely correlated with frequency and therefore low-band radiating elements are typically the largest radiating elements in a base station antenna. Most cellular operators prefer base station antennas that include at least two low-band linear arrays (e.g., to support 4xMIMO communications) because low-band RF signals pass more readily through physical obstacles such as trees, buildings, hills, etc. than do mid-band and high-band RF signals.

In order to fit larger numbers of arrays in a base station antenna, the radiating elements of the mid-band and/or high-band arrays are often mounted behind the radiating elements of the low-band linear arrays. Unfortunately, the low-band radiating elements can cause scattering of the RF energy emitted by the higher frequency band (mid-band or high-band) radiating elements. Scattering is undesirable as it changes the shape of the antenna beams generated by the higher frequency band array in both the azimuth and elevation planes. Scattering tends to increase the azimuth and elevation beamwidths of the higher frequency band antenna beams, which acts to reduce the gain, degrade the front-to-back ratio, and/or increase the interference that the antenna beams generate in neighboring sectors.

Two different types of scattering can occur. First, the scattering may occur because conductive structures of the low-band radiating elements can reflect RF energy transmitted by the higher frequency band radiating elements, causing the higher band RF energy to exit the base station antenna in undesired directions and/or in a desired direction but with a phase that causes the reflected RF energy to destructively combine with non-reflected RF energy.

Second, the scattering may also occur because certain conductive structure of the low-band radiating elements may have electrical lengths that make the structure resonant in the operating frequency band of the higher frequency band array, which may occur if the conductive structure has an electrical length that is about ½ a wavelength or about a full wavelength of a frequency within the operating frequency band of the higher frequency band array. Since the mid-band operating frequency range includes frequencies that are twice certain frequencies in the low-band operating frequency range, and the high-band operating frequency range includes frequencies that are four times certain frequencies in the low-band operating frequency range, the dipole arms of the low-band radiating elements, which typically have an electrical length of about ¼ of a center wavelength of the low-band operating frequency range, are typically resonant in at least portions of both the mid-band and high-band operating frequency ranges. When the low-band dipole arms are resonant in either the mid-band or the high-band, RF energy transmitted by the higher frequency band array may couple to the dipole arms of nearby low-band radiating elements and then re-radiate therefrom, resulting again in the higher frequency band RF exiting the base station antenna in undesired directions and/or destructively combining with other RF energy emitted by the higher frequency band array.

“Cloaking” radiating elements have dipole arms that are designed so that currents will largely not form thereon in response to RF radiation in pre-selected frequency ranges. The elements of the dipole arms of a cloaking radiating element that suppress RF currents in the pre-selected frequency band may be referred to herein as “cloaking structures”. Cloaking radiating elements can reduce or eliminate the second of the above-described types of scattering of higher frequency band radiation by the dipole arms of nearby lower frequency band radiating elements.

Pursuant to embodiments of the present invention, base station antennas are provided that include low-band radiating elements having cloaked dipole arms that may have reduced impact on nearby arrays of mid-band radiating elements. These low-band radiating elements may have very high levels of transparency with respect to mid-band RF radiation. The dipole arms of the radiating elements according to embodiments of the present invention may have cloaking structures with small physical footprints that can be implemented at a low cost. As a result, the size of the dipole arms may be kept the same or even reduced when implementing the cloaking structures. The cloaking structures may act to reduce the formation of mid-band currents on the dipole arms in response to mid-band RF radiation, which may ensure that the radiating elements are highly cloaked with respect to mid-band RF radiation, and substantially prevent mid-band RF currents from forming on the dipole arms of the low-band radiating elements.

The dipole arms of the radiating elements according to embodiments of the present invention may be cloaked dipole arms that are designed to suppress the formation of currents on the dipole arms in certain higher frequency bands. While the use of cloaking dipole arms may improve the performance of a multiband base station antenna, the cloaking design often increases the impedance of the dipole arms above 50 ohms such that the dipole arms may not have a good impedance match with feed stalk printed circuit boards (typically, the RF lines on feed stalk printed circuit boards are designed as 50 ohm RF transmission lines in order to be impedance matched with the RF transmission lines of a feed network that feeds the feed stalks). The feed stalk printed circuit boards used in the radiating elements according to embodiments of the present invention may include capacitive elements such as conductive traces that may form impedance matching circuits that better match the RF feed lines on the feed stalk printed circuit boards to the dipole arms, thereby expanding the operating bandwidth of the radiating elements.

Before discussing the radiating elements according to embodiments of the present invention in more detail, it is helpful to discuss the design of an example conventional multiband base station antenna.

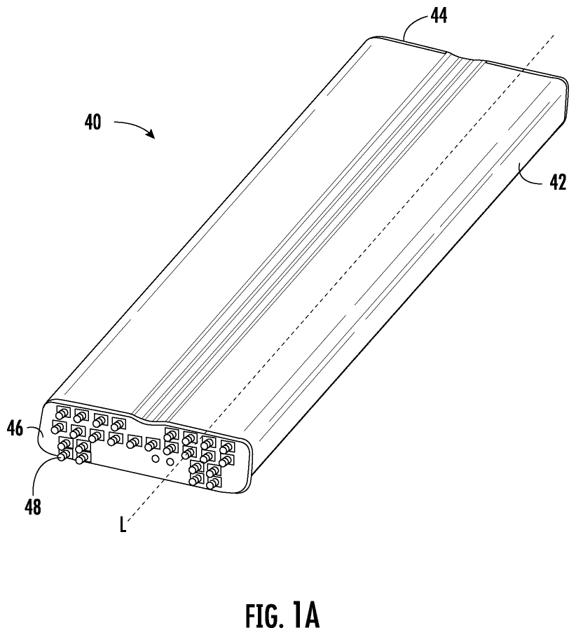

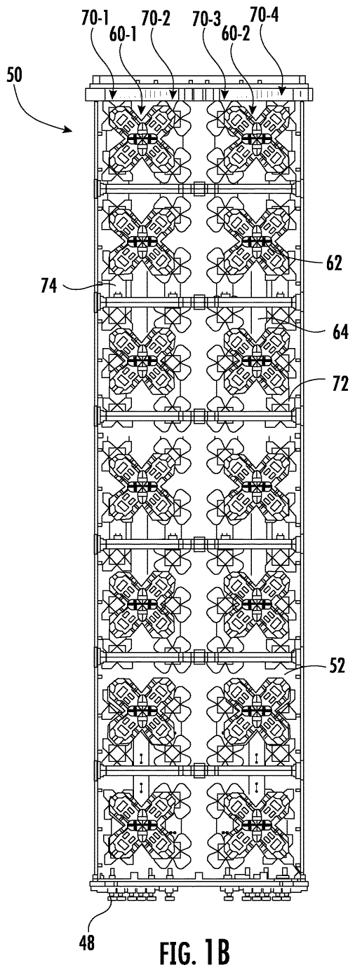

FIG. 1A is a schematic perspective view of a conventional multiband base station antenna 40. In the description that follows, the base station antenna 40 and the radiating elements included therein will be described using terms that assume that the base station antenna 40 is mounted for normal use on a tower with a longitudinal axis of the base station antenna 40 extending along a vertical axis and the front surface of the base station antenna 40 mounted opposite the tower (or other mounting structure) so as to point toward the coverage area for the base station antenna 40.

As shown in FIG. 1A, the base station antenna 40 is an elongated structure that extends along a longitudinal axis (L). The base station antenna 40 may have a tubular shape with a generally rectangular cross-section. The base station antenna 40 includes a tubular radome 42 and a top end cap 44. The base station antenna 40 also includes a bottom end cap 46 which includes a plurality of RF ports 48 such as RF connectors mounted therein. The RF ports 48 extend through the bottom end cap 46. The radome 42, top end cap 44 and bottom end cap 46 may form an external housing for the antenna 40. An antenna assembly 50 (see FIG. 1B) is contained within the external housing. The antenna assembly 50 may be slidably inserted into the radome 42 from either the top or bottom before the top end cap 44 or bottom end cap 46 are attached to the radome 42.

FIG. 1B is a schematic front view of the antenna assembly 50 of base station antenna 40. As shown in FIG. 1B, the antenna assembly 50 includes a reflector 52 which may comprise a metallic surface (e.g., a sheet of aluminium) that reflects forwardly RF radiation that is emitted rearwardly by the radiating elements included in the base station antenna 40 and which also serves as a ground plane for the radiating elements. Various mechanical and electronic components of the antenna (not shown) may be mounted behind the reflector 52 such as, for example, phase shifters, remote electronic tilt units, mechanical linkages, controllers, diplexers, and the like.

A plurality of linear arrays of dual-polarized radiating elements are mounted to extend forwardly from the reflector 52. The linear arrays include first and second low-band linear arrays 60-1, 60-2 that each comprise a respective vertically-extending column of low-band radiating elements 62, and first through fourth mid-band linear arrays 70-1 through 70-4 that each comprise a respective vertically-extending column of mid-band radiating elements 72. The base station antenna 40 is often referred to as a 2L4H antenna, indicating that the antenna 40 includes two low-band linear arrays 60 and four higher-band (here mid-band) linear arrays 70. The RF ports 48 are used to connect the linear arrays 60, 70 to one or more external radios (not shown). It should be noted that herein like elements may be referred to individually by their full reference numeral (e.g., the first low-band linear array 60-1) and may be referred to collectively by the first part of their reference numeral (e.g., the low-band linear arrays 60).

In some embodiments, the first low-band linear array 60-1 is positioned between the first and second mid-band linear arrays 70-1, 70-2, and the second low-band linear array 60-2 is positioned between the third and fourth mid-band linear arrays 70-3, 70-4. It will be appreciated that base station antenna 40 illustrates one typical layout of arrays of low-band and mid-band linear arrays 60, 70. It will likewise be appreciated that the number and/or types of arrays may be varied from what is shown based on applications and/or customer requirements, as may the positioning of the linear arrays on the reflector 52 and/or the number of radiating elements included in each linear array. For example, the base station antenna 40 could alternatively include one or more planar arrays of high-band radiating elements that replace the second and third linear arrays 70-2, 70-3 of mid-band radiating elements 72.

The low-band radiating elements 62 may be configured to transmit and receive signals in a first frequency band such as, for example, the 617-960 MHz frequency range or a portion thereof (and most typically, in the 696-960 MHz frequency band). The mid-band radiating elements 72 may be configured to transmit and receive signals in a second frequency band such as, for example, the 1427-2690 MHz frequency range or a portion thereof. In some embodiments, the mid-band radiating elements in linear arrays 70-1 and 70-4 include mid-band radiating elements that are configured to transmit and receive RF signals in the 1695-2690 MHz frequency band, while the mid-band radiating elements in linear arrays 70-2 and 70-3 include mid-band radiating elements that are configured to transmit and receive RF signals in the 1427-2690 MHz frequency band, but the present disclosure is not limited thereto. The radiating elements 62, 72 may be dual polarized radiating elements (e.g., −45°/+45 ° cross-dipole radiating elements), and hence each linear array 60, 70 may be used to form a pair of antenna beams, namely an antenna beam for each of the two polarizations at which the dual-polarized radiating elements 62, 72 are designed to transmit and receive RF signals. The radiating elements 62, 72 are mounted on feed board printed circuit boards (herein “feedboards”) 64, 74 that couple RF signals to and from the individual radiating elements 62, 72. One or more radiating elements 62, 72 may be mounted on each feedboard 64, 74. Cables (not shown) may be used to connect each feed board printed circuit board to other components of the antenna such as diplexers, phase shifters or the like.

As shown in FIG. 1B, the low-band radiating elements 62 in each low-band linear array 60-1, 60-2 extend forwardly from the reflector 52 and typically overlap one or more of the mid-band radiating elements 72 in the first through fourth mid-band linear arrays 70-1 through 70-4 in a forward direction of the base station antenna. As such, metal elements of the low-band radiating elements 62 may partially block/reflect the RF radiation emitted by the first through fourth mid-band linear arrays 70-1 through 70-4 and/or the higher-band RF radiation may induce currents on metal elements of the low-band radiating elements 62 that then reradiate the higher-band radiation in ways that act to distort the shape of the antenna beams generated by the first through fourth mid-band linear arrays 70-1 through 70-4.

As discussed above, pursuant to embodiments of the present invention, cross-dipole low-band radiating elements are provided that have dipole arms that may be substantially transparent to RF energy in the mid-band operating frequency band. The dipole arms of the low-band radiating elements may have cloaking structures with small physical footprints that can be implemented at a low cost, with the cloaking structures comprised of resonant circuits that act to reduce the formation of higher-band currents on the dipole arms. Embodiments of the present invention thus provide low-band radiating elements with small footprints that are highly cloaked with respect to higher-band RF radiation and can be implemented at a low cost. As used herein, the footprint of a radiating element refers to the area of the smallest rectangle that encloses the dipole radiators of the radiating element when the radiating element is viewed from the front.

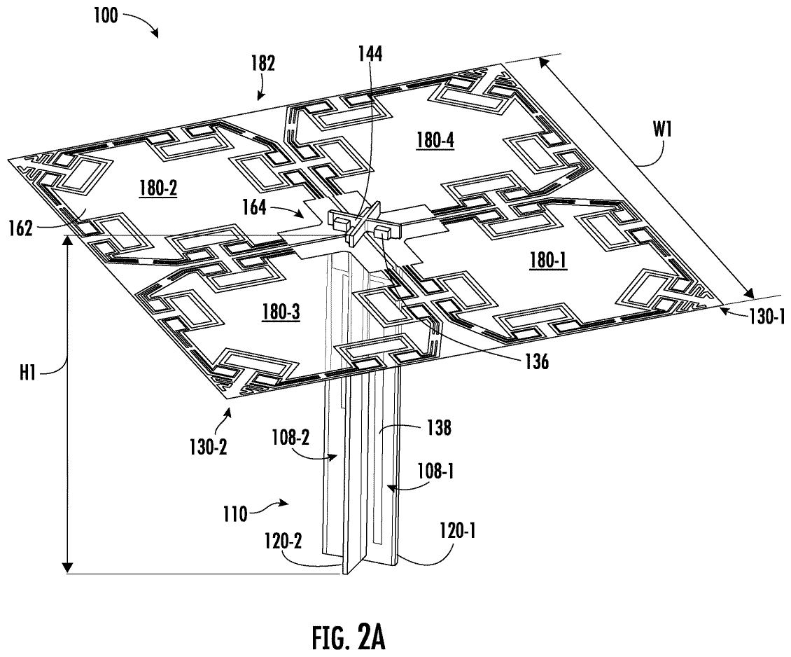

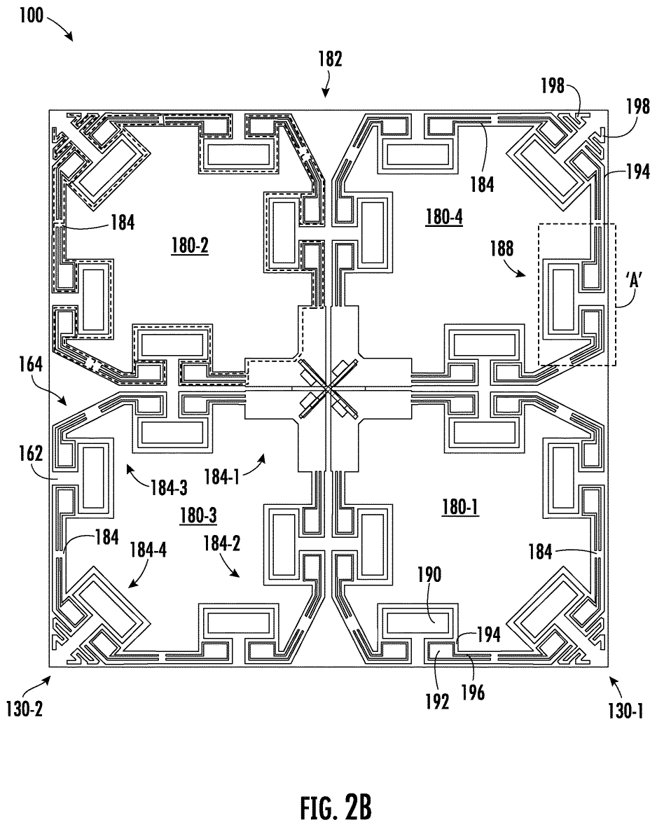

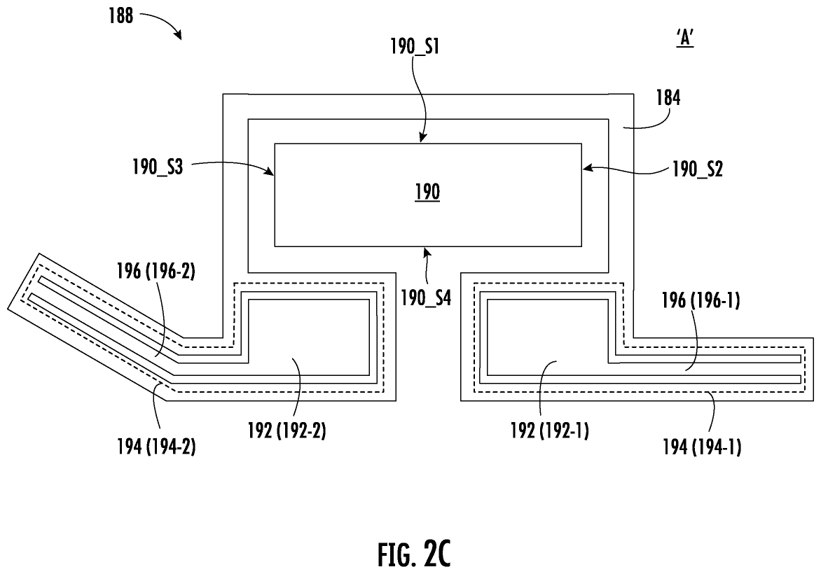

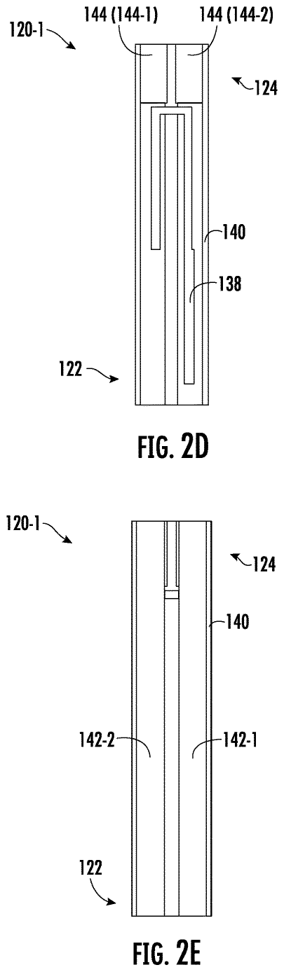

FIGS. 2A-2E illustrate a low cost, cloaked, cross-dipole low-band radiating element 100 according to embodiments of the present invention. In particular, FIG. 2A is a schematic front perspective view of the low-band radiating element 100. FIG. 2B is a front view of the four dipole arms 180 included in the radiating element 100. FIG. 2C is an enlarged view of a region ‘A’ of FIG. 2B. Finally, FIGS. 2D and 2E are side views illustrating the first and second major surfaces, respectively, of a feed stalk printed circuit board 120-1 included in the radiating element 100. The low-band radiating element 100 may, for example, be used in place of some or all of the low-band radiating elements 62 that are included in the base station antenna 40 of FIGS. 1A and 1B to provide a base station antenna according to embodiments of the present invention. The base station antennas according to embodiments of the present invention may be used, for example, as sector base station antennas in the above-described base stations of a cellular communications network.

Referring to FIGS. 2A-2E, the low-band radiating element 100 includes a feed stalk 110 and first and second dipole radiators 130-1, 130-2. The feed stalk 110 comprises first and second feed stalk printed circuit boards 120-1, 120-2. Each feed stalk printed circuit board 120-1, 120-2 includes a respective RF feed line 108-1, 108-2 that carry RF signals between first and second RF transmission lines (not shown) that connect to the radiating element 100 to pass RF signals to and from the radiating element 100. Each such RF transmission line may comprise, for example, a coaxial cable or a microstrip transmission line on a feed board printed circuit board.

As shown in FIGS. 2A, 2D and 2E, each feed stalk printed circuit board 120 has a base 122 and a distal end 124 that is positioned forwardly of the base 122. Feed stalk printed circuit boards 120-1 and 120-2 are arranged perpendicular to each other and mated together, so that the two mated feed stalk printed circuit boards 120-1, 120-2 have a cross-shape when viewed from the front. Although FIGS. 2D and 2E only illustrate the first feed stalk printed circuit board 120-1, it will be appreciated that the second feed stalk printed circuit board 120-2 may have substantially the same design as the first feed stalk printed circuit board 120-1, and thus the following description of the first feed stalk printed circuit board 120-1 is also applicable to the second feed stalk printed circuit board 120-2, unless the context clearly indicates otherwise.

As shown in FIGS. 2D and 2E, a signal line 138 is formed on a first side of the first feed stalk printed circuit board 120-1, and a twin line transmission line structure is formed on a second side of the first feed stalk printed circuit board 120-1. The twin line transmission line structure comprises first and second ground lines 142-1, 142-2 that are implemented as first and second metallized regions (e.g., first and second widened metal traces) formed on a dielectric substrate 140 of the first feed stalk printed circuit board 120-1. The first and second ground lines 142-1, 142-2 extend from the base 122 of the first feed stalk printed circuit board 120-1 to the distal end 124 thereof. Each ground line 142-1, 142-2 is coupled to the ground conductor of a first RF transmission line (not shown) that feeds radiating element 100. The first and second ground lines 142-1, 142-2 may each have an electrical length of about ¼ the center wavelength of radiating element 100.

The signal line 138 overlaps the first and second ground lines 142-1, 142-2 and together the signal line 138 and the first and second ground lines 142-1, 142-2 form the first feed line 108-1. Similarly, the second feed stalk printed circuit board 120-2 includes a signal line and first and second ground lines that together form the second feed line 108-2. The feed stalk printed circuit boards 120 may be mechanically mounted on a feedboard (e.g., see the feedboards 64, 74 of FIG. 1B) and a pair of RF transmission lines on the feedboard may be electrically connected to the first and second feed lines 108-1, 108-2 that are provided on the feed stalk printed circuit boards 120. The radiating element 100 may be mounted to extend forwardly from the feedboard with the feed stalk printed circuit boards 120 extending perpendicularly to the feedboard.

The signal line 138 may be implemented as a metallized region (e.g., a narrow, elongated metal trace) formed on the dielectric substrate 140 of the first feed stalk printed circuit board 120-1 and may take the form of a hook-balun. The hook-balun feed line may be used to capacitively feed the two dipole arms 180 of a respective dipole radiator 130. The signal line 138 is coupled to the signal conductor of a first RF transmission line (not shown) that feeds radiating element 100.

First and second signal pads 144-1, 144-2 may be implemented as metallized regions (e.g., conductive metal traces) formed on the dielectric substrate 140 of the first feed stalk printed circuit board 120-1. The signal pads 144 may function as capacitive elements that form impedance matching circuits to better match the first and second feed lines 108-1, 108-2 on the feed stalk printed circuit boards 120 to the dipole arms 180, thereby expanding the operating bandwidth of the radiating element 100.

As shown in FIG. 2A, solder joints 136 are formed that electrically connect the feed stalk 110 to the dipole radiators 130. For example, the solder joints 136 may galvanically couple the signal pads 144 of each feed stalk printed circuit board 120 to a metallization pattern 164 of a dipole radiator printed circuit board 182, such that the first and second feed stalk printed circuit boards 120-1, 120-2 are electrically connected to the first and second dipole radiators 130-1, 130-2, respectively.

Although FIG. 2A illustrates that the feed stalk 110 includes the first and second feed stalk printed circuit boards 120-1, 120-2, embodiments of the present invention are not limited thereto. In other embodiments, the feed stalk 110 may be implemented, for example, using a single feed stalk printed circuit board that includes first and second feed lines that feed the respective first and second dipole radiators 130-1, 130-2 of the radiating element 100.

The dipole radiators 130-1, 130-2 are positioned at the distal ends 124 of the feed stalk printed circuit boards 120 and may be physically mounted on the feed stalk printed circuit boards 120. The first dipole radiator 130-1 extends along a first axis and the second dipole radiator 130-2 extends along a second axis that is generally perpendicular to the first axis. The first dipole radiator 130-1 includes first and second dipole arms 180-1, 180-2, and the second dipole radiator 130-2 includes third and fourth dipole arms 180-3, 180-4.

The dipole radiators 130-1, 130-2 may be formed in the dipole radiator printed circuit board 182. In FIG. 2B, only the dipole radiator printed circuit board 182 of the radiating element 100 is shown. The dipole radiator printed circuit board 182 may include a dielectric substrate 162 with the metallization pattern 164 formed on a first major surface thereof (i.e., on one side thereof). Although FIGS. 2A-C illustrate that the dipole arms 180 are formed in the dipole radiator printed circuit board 182, embodiments of the present invention are not limited thereto. In other embodiments, the dipole arms 180 (and their respective cloaking structures) may be formed, for example, as sheet metal dipole arms.

A height H1 of the low-band radiating element 100 may be in a range from 66 millimeters (mm) to 86 mm, and in some embodiments, may be approximately 76 mm. In other words, the height H1 of the dipole radiators 130 (e.g., relative to a lower surface of the feed stalk 110 or relative to a reflector, such as the reflector 52 of FIG. 1B) may be in a range from 66 mm to 86 mm, and in some embodiments, may be approximately 76 mm. A width W1 of the low-band radiating element 100 may be in a range from 100 mm to 120 mm, and in some embodiments, may be approximately 110 mm. In other words, the dipole radiators 130 of the radiating element 100 may define a square that has the width W1 in a range from 100 mm to 120 mm (e.g., 110 mm) on each side when viewed from the front. Since the widths of many base station antennas are a function of the size of the low-band radiating elements, the radiating elements 100 according to embodiments of the present invention may allow for the size of many base station antennas to be reduced while providing performance improvements.

Dipole arms 180-1 and 180-2 of the first dipole radiator 130-1 are center fed by the first RF feed line 108-1 on the first feed stalk printed circuit board 120-1 and radiate together at a first polarization. In some embodiments, the first dipole radiator 130-1 is designed to transmit and receive signals having a slant +45° linear polarization. Dipole arms 180-3 and 180-4 of the second dipole radiator 130-2 are center fed by the second RF feed line 108-2 on the second feed stalk printed circuit board 120-2 and radiate together at a second polarization that is orthogonal to the first polarization. In some embodiments, the second dipole radiator 130-2 is designed to transmit and receive signals having a slant −45° linear polarization.

The dipole arms 180 are cloaking dipole arms that have a cloaking structure. For example, the dipole radiators 130-1, 130-2 may have an elongated “figure 8” shape where each dipole arm 180 includes a conductive loop 184. In FIG. 2B, the conductive loop 184 included in the second dipole arm 180-2 is shown by dotted lines to help illustrate embodiments of the present invention. For example, each conductive loop 184 may have a generally oval shape that forms a closed loop. As shown in FIG. 2B, each conductive loop 184 includes a base section 184-1, first and second side sections 184-2, 184-3 that extend from the base section 184-1, and a distal section 184-4 that connects distal ends of the first and second side sections 184-2, 184-3.

Each dipole arm 180 may include a plurality of conductive segments 188. The conductive segments 188 are located around the perimeter of each dipole arm 180 and may be designed to function as resonant circuits (e.g., LC circuits) that act to reduce the formation of higher-band currents on each dipole arm 180. As shown in FIG. 2B, each dipole arm 180 may include at least five conductive segments 188, although embodiments of the present invention are not limited thereto. For example, a first side of each dipole arm 180 may include at least two conductive segments 188, a second side of each dipole arm 180 opposite the first side may include at least two conductive segments 188, and an end of each dipole arm 180 (i.e., a distal end of each dipole arm 180) may include at least one conductive segment 188. The first side of each dipole arm 180 may include the first side section 184-2 of a respective conductive loop 184, the second side of each dipole arm 180 may include the second side section 184-3 of a respective conductive loop 184, and the end of each dipole arm 180 may include the distal section 184-4 of a respective conductive loop 184.

As shown in FIGS. 2B and 2C, each conductive segment 188 includes a portion of the conductive loop 184 and a first conductive pad 190. In FIG. 2C, only the conductive segment 188 is shown and the dielectric substrate 162 is omitted to help illustrate embodiments of the present invention. Each dipole arm 180 may include at least five of the first conductive pads 190, although embodiments of the present invention are not limited thereto. The first conductive pad 190 is spaced apart from (i.e., separated from) the conductive loop 184 and is only capacitively coupled to the conductive loop 184. That is, the first conductive pad 190 may not be galvanically coupled to the conductive loop 184 and instead may only be capacitively coupled to the conductive loop 184.

The conductive loop 184 may surround the first conductive pad 190 and may enclose all but one side of the first conductive pad 190 in a front view. For example, the conductive loop 184 may extend adjacent the first conductive pad 190 on all sides of the first conductive pad 190 in a front view. In other words, the conductive loop 184 may extend adjacent first through fourth sides 190_S1 through 190_S4 of the first conductive pad 190 in a front view. It will be understood that “an element A surrounds an element B” (or similar language) as used herein means that the element A is at least partially around the element B but does not necessarily mean that the element A completely encloses the element B.

The first side 190_S1 of the first conductive pad 190 faces an interior of the respective dipole arm 180. The second and third sides 190_S2 and 190_S3 of the first conductive pad 190 extend perpendicular to the first side 190_S1 of the first conductive pad 190 in a front view. The fourth side 190_S4 of the first conductive pad 190 is opposite the first side 190_S1 and faces away from the interior of the respective dipole arm 180. The conductive loop 184 may enclose the first side 190_S1, the second side 190_S2, and the third side 190_S3 of the first conductive pad 190. As shown in FIGS. 2B and 2C, the conductive loop 184 may not completely enclose the fourth side 190_S4 of the first conductive pad 190, and thus the first conductive pad 190 may not be enclosed by the conductive loop 184 in a front view.

Each first conductive pad 190 may have a generally rectangular shape. For example, a length of the first conductive pad 190 in a first direction parallel to a major surface of the first conductive pad 190 (e.g., a top surface of the first conductive pad 190) may be greater than a width of the first conductive pad 190 in a second direction parallel to the major surface of the first conductive pad 190 and perpendicular to the first direction. In some embodiments, each first conductive pad 190 may be located inward of a majority of the conductive loop 184. For example, each conductive loop 184 has a “path length”, which refers to the distance that an electrical current flowing through the most direct current path of the conductive loop 184 will travel when traversing the conductive loop 184. In some embodiments, the first conductive pad 190 may be located further inward (e.g., relative to the perimeter of the respective dipole arm 180) than at least half of the path length of the respective conductive loop 184, which may allow for the first conductive pads 190 to be implemented on each dipole arm 180 without having to increase the size of each dipole arm 180. For example, portions of each conductive loop 184 that are located closer to the interior of the respective dipole arm 180 than the first conductive pads 190 are may collectively amount to less than half of the path length of each conductive loop 184, although embodiments of the present invention are not limited thereto.

As shown in FIG. 2B, portions of each conductive loop 184 may extend inward in a direction away from the perimeter of the respective dipole arm 180 and respectively surround the first conductive pads 190. For example, first portions of each conductive loop 184 may extend adjacent the perimeter of the respective dipole arm 180, and second portions of each conductive loop 184 may protrude inward from the first portions in a direction away from the perimeter of the respective dipole arm 180 to respectively surround the first conductive pads 190. The first portions of each conductive loop 184 may be closer to the perimeter of the respective dipole arm 180 than the second portions of each conductive loop 184.

As shown in FIGS. 2B and 2C, each conductive loop 184 includes a plurality of second conductive pads 192, a plurality of embedded loops 194, and a plurality of arm segments 196. In FIG. 2C, the embedded loops 194 are shown by dotted lines to help illustrate embodiments of the present invention. The second conductive pads 192 are respectively located in the interiors of the embedded loops 194. The arm segments 196 respectively extend between the embedded loops 194 and the second conductive pads 192. The arm segments 196 may electrically connect the second conductive pads 192 to the embedded loops 194, respectively. The second conductive pads 192, the embedded loops 194, and the arm segments 196 are physically (or integrally) connected within the conductive loop 184 and are considered as part of the conductive loop 184 herein.

The arm segments 196 may physically connect the second conductive pads 192 to the embedded loops 194, respectively, such that the second conductive pads 192 and the arm segments 196 are galvanically coupled to the embedded loops 194, respectively. The second conductive pads 192 may generally have a rectangular shape. The embedded loops 194 may each form a closed loop within the respective conductive loop 184, and the interiors of the embedded loops 194 may generally have an ‘L’ shape. The arm segments 196 may generally have a line shape. As shown in FIG. 2B, each dipole arm 180 may include at least ten of the second conductive pads 192, at least ten of the embedded loops 194, and at least ten of the arm segments 196, although embodiments of the present invention are not limited thereto.

As shown in FIG. 2C, each conductive segment 188 of a respective dipole arm 180 may include a portion of the respective conductive loop 184 that comprises two second conductive pads 192-1, 192-2, two embedded loops 194-1, 194-2, and two arm segments 196-1, 196-2. A first one of the second conductive pads 192-1 may be located in an interior of a first embedded loop 194-1, and a second one of the second conductive pads 192-2 may be located in an interior of a second embedded loop 194-2. A first arm segment 196-1 may physically connect the first one of the second conductive pads 192-1 to the first embedded loop 194-1, so that the first one of the second conductive pads 192-1 is galvanically coupled to the first embedded loop 194-1. Similarly, a second arm segment 196-2 may physically connect the second one of the second conductive pads 192-2 to the second embedded loop 194-2, so that the second one of the second conductive pads 192-2 is galvanically coupled to the second embedded loop 194-2.

A length of the arm segments 196 may be greater than a length of the second conductive pads 192. As used herein, the length of the arm segments 196 and the length of the second conductive pads 192 refers to a longest dimension of the arm segments 196 and a longest dimension of the second conductive pads 192, respectively, in a front view. When the arm segment 196 has a bend (e.g., see the second arm segment 196-2), the length of the arm segment 196 as used herein refers to the longest dimension of the arm segment 196 along its extension direction, including any bends or curvature along the extension direction. A width of the arm segments 196 may be less than a width of the second conductive pads 192. As used herein, the width of the arm segments 196 and the width of the second conductive pads 192 refers to a shortest dimension of the arm segments 196 and a shortest dimension of the second conductive pads 192, respectively, in a front view.

As shown in FIG. 2C, the first embedded loop 194-1 and the second embedded loop 194-2 included in the conductive segment 188 are adjacent each other. Similarly, the first one of the second conductive pads 192-1 and the second one of the second conductive pads 192-2 included in the conductive segment 188 are adjacent each other. The first one of the second conductive pads 192-1 and the second one of the second conductive pads 192-2 may have a same shape. As shown in FIGS. 2B and 2C, a portion of the conductive loop 184 extends inward in a first direction away from a perimeter of the respective dipole arm 180, and the first one of the second conductive pads 192-1 and the second one of the second conductive pads 192-2 are spaced apart from each other in a second direction perpendicular to the first direction. The first conductive pad 190 included in the conductive segment 188 may be surrounded by the portion of the conductive loop 184 that extends inward in the first direction away from the perimeter of the respective dipole arm 180. The first conductive pad 190 may be adjacent the first one of the second conductive pads 192-1 and the second one of the second conductive pads 192-2 (e.g., in the first direction). The first conductive pad 190 may be spaced apart from the first one of the second conductive pads 192-1 and the second one of the second conductive pads 192-2 in the first direction. An area of the first conductive pad 190 may be greater than an area of the second conductive pads 192. The second conductive pads 192 may have a same area.

As shown in FIG. 2B, the conductive loop 184 of each dipole arm 180 includes a pair of meandered segments 198. The meandered segments 198 are adjacent a distal end of each dipole arm 180. As used herein, the distal end of each dipole arm 180 refers to an outermost end of each dipole arm 180. For example, the distal end of each dipole arm 180 may be an end that is farthest from the feed stalk 110. The meandered segments 198 are included in the distal section 184-4 of each conductive loop 184. The meandered segments 198 may extend outward from the conductive loop 184, away from the interior of the respective dipole arm 180 and may terminate in free ends. That is, each meandered segment 198 may have a free end that does not reconnect to the conductive loop 184. For example, each meandered segment 198 may extend outward from a respective embedded loop 194 of the conductive loop 184 and terminate in a free end.

Each meandered segment 198 may have a wave structure that includes at least one outer bend and at least one inner bend. The pair of meandered segments 198 included in each dipole arm 180 are adjacent each other and extend outward from the conductive loop 184 in a symmetrical manner. The meandered segments 198 increase the path length (i.e., electrical length) of each conductive loop 184, which may allow for the dipole arms 180 (i.e., the conductive loops 184) to achieve a desired electrical length in a smaller physical space. As a result, the footprint of the dipole arms 180 (i.e., the footprint of the cloaking structure implemented on the dipole arms 180) may be reduced, allowing for the size of the low-band radiating element 100 to be kept the same or even reduced as compared to a conventional low-band radiating element.

The metallization pattern 164 on the first major surface of the dielectric substrate 162 includes the conductive loops 184 and the first conductive pads 190. That is, the metallization pattern 164 includes the meandered segments 198 and the conductive segments 188 comprising the first conductive pads 190, the second conductive pads 192, the embedded loops 194, and the arm segments 196. As used herein, the conductive loops 184, the conductive segments 188, the first conductive pads 190, the second conductive pads 192, the embedded loops 194, the arm segments 196, and/or the meandered segments 198 may also be referred to as conductive elements of the dipole arms 180.

In some embodiments, the dipole radiator printed circuit board 182 may not include another metallization pattern on a second major surface of the dielectric substrate 162 opposite the first major surface of the dielectric substrate 162 on which the metallization pattern 164 is formed. In other embodiments, the dipole radiator printed circuit board 182 may include another metallization pattern on the second major surface of the dielectric substrate 162 opposite the first major surface, and the first conductive pads 190 may be free of overlap in a direction perpendicular to the first major surface of the dielectric substrate 162 with any conductive elements included in the metallization pattern on the second major surface of the dielectric substrate 162. For example, the first conductive pads 190 may not be galvanically coupled to any conductive elements of the dipole radiator printed circuit board 182. As used herein, “an element A overlaps an element B in a direction X” (or similar language) means that there is at least one straight line that extends in the direction X and intersects both the elements A and B.

In some embodiments, the first through fourth dipole arms 180-1 through 180-4 are designed to support service in some or all of the 617-960 MHz frequency band (particularly, a 690-960 MHz frequency) and are substantially transparent to RF radiation in a 1400-2700 MHz frequency band (i.e., a 1.4-2.7 GHz frequency band). In other words, the low-band radiating element 100 may operate over some or all of the 617-960 MHz low-band frequency range and may provide sufficient cloaking levels over a broad frequency range of 1400-2700 MHz.

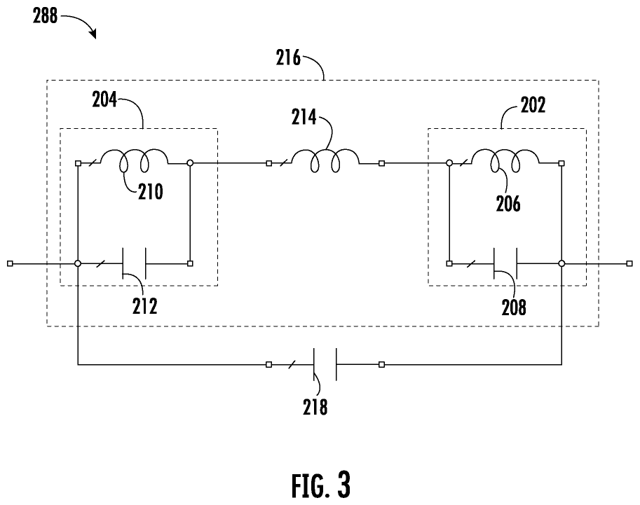

According to embodiments of the present invention, the conductive segments 188 of each dipole arm 180 are designed to function as resonant circuits that act to reduce the formation of higher-band currents on each dipole arm 180. In particular, the conductive segments 188 may function as LC circuits that suppress higher-band currents, as will be discussed in greater detail below with reference to FIG. 3. Accordingly, the conductive segments 188 may be strategically arranged on (and around) the dipole arms 180 to act as high impedance sections that are designed to interrupt currents in the operating frequency band of mid-band radiating elements that could otherwise be induced on the dipole arms 180 of the low-band radiating element 100, without significantly impacting the ability of the low-band currents to flow on the dipole arms 180. Low-band currents may thus freely form and flow on the dipole arms 180 to ensure that the radiating element 100 has high directivity that is substantially equivalent to the directivity of a conventional low-band radiating element. The conductive segments 188 may allow for the low-band radiating element 100 to have a cloaking structure that is substantially transparent to mid-band radiation, and hence may have little or no impact on the antenna beams formed by the mid-band radiating elements. In other words, the low-band radiating element 100 may be cloaked with respect to mid-band RF radiation so that such radiation will not induce substantial currents on the low-band dipole arms 180.

FIG. 3 is a circuit diagram illustrating an equivalent circuit 288 of the conductive segment 188 of FIG. 2C according to embodiments of the present invention.

As shown in FIG. 3, the equivalent circuit 288 includes a first LC circuit 202 (shown by dashed lines) and a second LC circuit 204 (shown by dashed lines). The first LC circuit 202 includes a first inductive element 206 and a first capacitive element 208 connected in electrical parallel. The second LC circuit 204 includes a second inductive element 210 and a second capacitive element 212 connected in electrical parallel.

The equivalent circuit 288 further includes a third inductive element 214 connected in electrical series between the first LC circuit 202 and the second LC circuit 204. That is, the first LC circuit 202, the third inductive element 214, and the second LC circuit 204 are connected to each other in electrical series. The first LC circuit 202, the second LC circuit 204, and the third inductive element 214 that are connected in electrical series provide a third LC circuit 216 (shown by dashed lines) of the equivalent circuit 288. The equivalent circuit 288 further includes a third capacitive element 218 connected in electrical parallel with the third LC circuit 216.

As shown in FIGS. 2C and 3, the first embedded loop 194-1 is configured to function as the first inductive element 206, and the first one of the second conductive pads 192-1 is configured to capacitively couple with the first embedded loop 194-1 to form the first capacitive element 208. The first embedded loop 194-1, the first one of the second conductive pads 192-1, and the first arm segment 196-1 together provide the first LC circuit 202.

The second embedded loop 194-2 is configured to function as the second inductive element 210, and the second one of the second conductive pads 192-2 is configured to capacitively couple with the second embedded loop 194-2 to form the second capacitive element 212. The second embedded loop 194-2, the second one of the second conductive pads 192-2, and the second arm segment 196-2 together provide the second LC circuit 204.

The portion of the conductive loop 184 that extends adjacent the first conductive pad 190 (i.e., that surrounds the first conductive pad 190) is configured to function as the third inductive element 214. The second conductive pads 192-1, 192-2, the arm segments 196-1, 196-2, the embedded loops 194-1, 194-2, and the portion of the conductive loop 184 are galvanically coupled to each other and together form the third LC circuit 216. Finally, the first conductive pad 190 is configured to capacitively couple with a portion of the conductive loop 184 to form the third capacitive element 218. Accordingly, the conductive segment 188 of FIG. 2C is configured to provide the equivalent circuit 288 of FIG. 3.

The first inductive element 206 and the second inductive element 210 may be configured to have substantially the same inductance. For example, the first inductive element 206 and the second inductive element 210 may each have an inductance (i.e., an inductance value) of approximately 5 nanohenries (nH), although embodiments of the present invention are not limited thereto. The third inductive element 214 may be configured to have an inductance greater than that of the first inductive element 206 and the second inductive element 210. In some embodiments, the third inductive element 214 may have an inductance that is at least five times greater than the inductance of the first inductive element 206 and the inductance of the second inductive element 210. For example, the third inductive element 214 may have an inductance of approximately 28 nH, although embodiments of the present invention are not limited thereto.

The first capacitive element 208 and the second capacitive element 212 may be configured to have substantially the same capacitance. For example, the first capacitive element 208 and the second capacitive element 212 may each have a capacitance (i.e., a capacitance value) of approximately 0.11 picofarads (pF), although embodiments of the present invention are not limited thereto. The third capacitive element 218 may be configured to have a capacitance greater than that of the first capacitive element 208 and the second capacitive element 212. In some embodiments, the third capacitive element 218 may have a capacitance that is at least 1.5 (one and a half) times greater than the capacitance of the first capacitive element 208 and the capacitance of the second capacitive element 212. For example, the third capacitive element 218 may have a capacitance of approximately 0.18 pF, although embodiments of the present invention are not limited thereto.

The equivalent circuit 288 functions based on principles of parallel resonance where inductive elements and capacitive elements are connected in electrical parallel and are tuned such that the equivalent circuit 288 acts as a low-impedance path for lower frequency band currents while acting as a high-impedance path for higher frequency band currents. For example, the equivalent circuit 288 may be configured to provide a stop band of 1400-2700 MHz (i.e., 1.4-2.7 GHz) and may have an S21 value of less than −16 dB, indicating that the equivalent circuit 288 reduces signal transmission by more than 16 dB within the stopband frequency range of 1400-2700 MHz. Accordingly, the low-band radiating element 100 may have a cloaking structure that is substantially transparent to mid-band radiating elements. The low band radiating element 100 may be configured to support service in some or all of the 617-960 MHz frequency band while being substantially transparent to RF radiation in the 1400-2700 MHz frequency band.

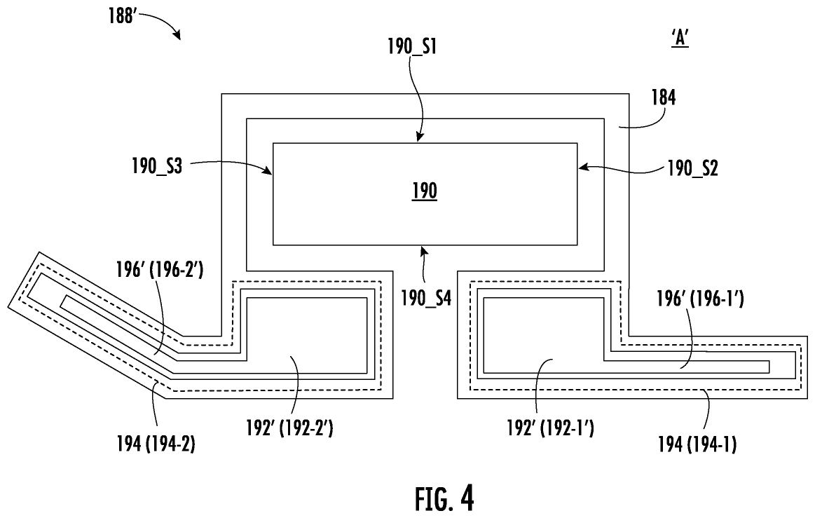

FIG. 4 is an enlarged view of the region ‘A’ of FIG. 2B according to further embodiments of the present invention. In FIG. 4, like reference numerals indicate like components described above, and duplicate descriptions of the same components may be omitted.

As shown in FIG. 4, the second conductive pads 192′ and the arm segments 196′ included in the conductive segment 188′ may not be physically connected to the embedded loops 194. The second conductive pads 192′ and the arm segments 196′ may thus not be galvanically coupled to the embedded loops 194 and instead may only be capacitively coupled to the embedded loops 194. In other words, the second conductive pads 192′ and the arm segments 196′ may only be capacitively coupled to the conductive loop 184. Although the second conductive pads 192′ and the arm segments 196′ are not physically (or integrally) connected to the embedded loops 194, it will be understood that the second conductive pads 192′ and the arm segments 196′ are still considered as part of the conductive loop 184 herein.

A first one of the second conductive pads 192-1′ and a first arm segment 196-1′ are located in an interior of a first embedded loop 194-1 and are enclosed by the first embedded loop 194-1 in a front view. A second one of the second conductive pads 192-2′ and a second arm segment 196-2′ are located in an interior of a second embedded loop 194-2 and are enclosed by the second embedded loop 194-2 in a front view. In some embodiments, different from that illustrated, the arm segments 196′ may be omitted. In this case, the second conductive pads 192′ may still be located in the interiors of the embedded loops 194, respectively, and may only be capacitively coupled to the embedded loops 194.

It will be appreciated that many modifications may be made to the above-described low-cost radiating elements without departing from the scope of the present invention. As one example, the feed stalk printed circuit boards may include cloaked RF feed lines as disclosed, for example, in PCT Patent Application Serial Nos. PCT/CN23/070056 and PCT/US24/10094, the entire content of each of which is hereby incorporated herein by reference. As another example, while the above-described radiating elements are formed using feed stalk printed circuit boards, in other embodiments other types of feed stalk implementations may be used such as, for example, sheet metal feed stalks. Further, while the dipole arms of the low-band radiating elements described above are implemented in a dipole radiator printed circuit board, it will be appreciated that embodiments of the present invention are not limited thereto. For example, in other embodiments, the dipole arms may be implemented as sheet metal dipole arms or using other metal structures. Finally, while the radiating elements according to embodiments of the present invention are described above as low-band radiating elements that cloak in the mid-band frequency range, it will be appreciated that they can be scaled in size and turned into mid-band or high-band radiating elements in other embodiments.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Herein, the term “substantially” means within +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, components, and/or groups, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A radiating element, comprising:
a feed stalk;
a first dipole radiator that comprises a first dipole arm and a second dipole arm; and
a second dipole radiator that comprises a third dipole arm and a fourth dipole arm,
wherein the first dipole arm comprises a conductive loop and a conductive pad that is at least partially surrounded by the conductive loop and is only capacitively coupled to the conductive loop.

2. The radiating element of claim 1, wherein the conductive pad is spaced apart from the conductive loop.

3. The radiating element of claim 1, wherein the conductive loop encloses all but one side of the conductive pad in a front view.

4. The radiating element of claim 1, wherein the conductive pad has a rectangular shape.

5. (canceled)

6. The radiating element of claim 1, wherein the conductive loop comprises a first meandered segment.

7. The radiating element of claim 6, wherein the first meandered segment is adjacent a distal end of the first dipole arm.

8. The radiating element of claim 6, wherein the first meandered segment extends outward from the conductive loop and terminates in a free end.

9-11. (canceled)

12. The radiating element of claim 1, wherein the first and second dipole radiators are formed in a dipole radiator printed circuit board that comprises a dielectric substrate and a metallization pattern on a major surface of the dielectric substrate, and
wherein the conductive loop and the conductive pad are part of the metallization pattern.

13. (canceled)

14. The radiating element of claim 1, wherein a portion of the conductive loop extends inward in a direction away from a perimeter of the first dipole arm and at least partially surrounds the conductive pad.

15-16. (canceled)

17. A radiating element, comprising:
a feed stalk;
a first dipole radiator that comprises a first dipole arm and a second dipole arm; and
a second dipole radiator that comprises a third dipole arm and a fourth dipole arm,
wherein the first dipole arm comprises a conductive loop, the conductive loop comprising:
a first embedded loop;
a first conductive pad located in an interior of the first embedded loop; and
a first arm segment that extends between the first embedded loop and the first conductive pad.

18. The radiating element of claim 17, wherein the first conductive pad has a rectangular shape.

19. The radiating element of claim 17, wherein the interior of the first embedded loop has an L shape.

20. The radiating element of claim 17, wherein the first conductive pad is galvanically coupled to the first embedded loop through the first arm segment.

21. The radiating element of claim 17, wherein the conductive loop further comprises a meandered segment that extends from the first embedded loop.

22-37. (canceled)

38. A radiating element, comprising:
a feed stalk;
a first dipole radiator that comprises a first dipole arm and a second dipole arm; and
a second dipole radiator that comprises a third dipole arm and a fourth dipole arm,
wherein the first dipole arm comprises one or more conductive elements that are configured to provide an equivalent circuit comprising:
a first LC circuit that comprises a first inductive element and a first capacitive element connected in electrical parallel;
a second LC circuit that comprises a second inductive element and a second capacitive element connected in electrical parallel; and
a third inductive element connected in electrical series between the first LC circuit and the second LC circuit.

39. The radiating element of claim 38, wherein an inductance value of the first inductive element is substantially equal to an inductance value of the second inductive element.

40. The radiating element of claim 38, wherein an inductance value of the third inductive element is greater than an inductance value of at least one of the first inductive element or the second inductive element.

41. (canceled)

42. The radiating element of claim 38, wherein a capacitance value of the first capacitive element is substantially equal to a capacitance value of the second capacitive element.

43. The radiating element of claim 38, wherein the first LC circuit, the second LC circuit, and the third inductive element connected in electrical series provide a third LC circuit of the equivalent circuit, and
wherein the equivalent circuit further comprises a third capacitive element connected in electrical parallel with the third LC circuit.

44-46. (canceled)

47. The radiating element of claim 38, wherein the one or more conductive elements are configured such that the first dipole arm is substantially transparent to RF radiation in a 1.4-2.7 GHz frequency band.
